(19) United States
(12) Patent Application Publication
(10) Pub. No.: US 2001/0023551 A1
(43) Pub. Date: Sep. 27, 2001

(54) Fishing artificial bait and fishing terminal tackle

(76) Inventor: Tatsuya Hattori, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/809,251

(22) Filed: Mar. 16, 2001

(30) Foreign Application Priority Data
Mar. 21, 2000 (JP) 2000-078252

(51) Int. Cl. A01K 85/00

(52) U.S. Cl. 43/42.32

(57) ABSTRACT

The present invention provides a fishing artificial bait and a fishing terminal tackle such that the silhouette of the artificial bait body is not visually obtrusive to the fish and the artificial bait body comes up on the surface of the water when the line is cut off due to a snag. The artificial bait of the present invention includes an artificial bait body and a through hole pierced through the artificial bait body so as to extend in the longitudinal direction or the transverse direction thereof. The artificial bait is a plug, and the artificial bait body is made of a material whose specific gravity is smaller (or greater in some cases) than that of water. The artificial bait body has a spindle shape, e.g., a fish shape, and is colored so as to resemble the pattern of a fish body. A hole for receiving and stopping a shank of the hook is provided in a rear portion of the through hole of the artificial bait body. Moreover, the fishing terminal tackle of the present invention includes a first artificial bait body having a through hole pierced therethrough, and a second artificial bait body having a through hole pierced therethrough, wherein the first artificial bait body and the second artificial bait body are coupled together via a line passing through the respective through holes, with a hook attached to an end of the line.

### BACKGROUND OF THE INVENTION

1. Field of the Invention

The present invention relates to a fishing artificial bait (lure) and, more particularly, to a lure which is used with the line being passed through the artificial bait body.

2. Description of the Related Art

Artificial baits, called “lures”, known in the prior art include hard lures such as those called “spoons”, “spinners” and “plugs” and soft lures such as those called “worms”. Generally, it is believed that a soft lure such as a plastic worm gives a better catching rate than a hard lure such as a plug. This is because a soft lure has a hook embedded in the body, thereby giving a form such that fish can only see the silhouette of the lure body.

FIG. 11A to FIG. 11C show conventional plugs. In each of the conventional plugs as illustrated in FIG. 11A to FIG. 11C, at least three eyes 1, 2 and 3, two split rings 4 and 5, and at least two hooks 8 and 9 are attached to the outside of an artificial bait body 10. A lip 6 is attached to some types of plugs as illustrated in FIG. 11A. These parts are, in many cases, made of metal, and thus seen by fish only as foreign objects. This prevents one from getting a good catching rate since the visual factor is critical for artificial baits.

Moreover, with a conventional plug, when the line is cut off due to a snag or by fish, the plug sinks onto the bottom of the water together with the fishing terminal tackle, thereby losing the plug, which is expensive. Leaving the fishing terminal tackle in the nature, which may contribute to the environmental destruction, is not preferred from the environmental protection point of view.

### SUMMARY OF THE INVENTION

An object of the present invention is to provide a fishing artificial bait such that the silhouette of the artificial bait body is not visually obtrusive to the fish.

Another object of the present invention is to provide a fishing artificial bait such that even if the line is cut off due to a snag, the artificial bait body comes up on the surface of the water.

Still another object of the present invention is to provide a fishing terminal tackle for realizing these objects.

A fishing artificial bait of the present invention includes: an artificial bait body; and a through hole pierced through the artificial bait body. The through hole extends in a longitudinal direction of the artificial bait body or in a transverse direction of the artificial bait body.

The artificial bait of the present invention is a plug, and the artificial bait body is made of a material whose specific gravity is smaller than that of water, including a synthetic resin, a natural material such as wood, or the like. The artificial bait body may alternatively be made of a material whose specific gravity is greater than that of water.

The through hole pierced through the artificial bait body is formed in a straight shape or a curved shape. The artificial bait body has a spindle shape, e.g., a fish shape, and is colored so as to resemble a pattern of a fish body.

A tube is inserted in the through hole of the artificial bait body.

A slope portion facing upwardly or a slope portion facing downwardly is provided on the front side of the artificial bait body. The fishing artificial bait of the present invention may further include a lip provided on the artificial bait body, e.g., on the lower side of a front portion of the artificial bait body.

A balance weight for keeping a balance of the artificial bait body is embedded in a bottom portion of the artificial bait body.

In a terminal tackle including the fishing artificial bait of the present invention, a hole for receiving and stopping a shank of a hook is provided in a rear portion of a through hole of an artificial bait body. Thus, the terminal tackle is comprised of the fishing artificial bait body and the through hole pierced through the artificial bait body, wherein a line is passed through the through hole, and the hook is attached to an end of the line.

Alternatively, a terminal tackle of the present invention includes: a first artificial bait body having a through hole pierced therethrough; and a second artificial bait body having a through hole pierced therethrough, wherein the first artificial bait body and the second artificial bait body are coupled together via a line passing through the respective through holes, with a hook attached to an end of the line.

The terminal tackle may be designed so that the specific gravity of the first artificial bait body and the specific gravity of the second artificial bait body are the same or different from each other. A hole for receiving and stopping a shank of a hook is provided in a rear portion of the through hole of the artificial bait body.

The hook used in the present invention is a branched hook which is branched into one or more hook points.

### BRIEF DESCRIPTION OF THE DRAWINGS

FIG. 1A to FIG. 1C illustrate a floating-type middle-range crankbait for searching through the middle layer, wherein

FIG. 1A is a side view,

FIG. 1B is a front view, and

FIG. 1C is a top view.

FIG. 2A and FIG. 2B illustrate a sinking-type bottom-range vibration bait for searching through the deep layer, wherein

FIG. 2A is a side view, and

FIG. 2B is a front view.

FIG. 3A and FIG. 3B illustrate a popper-type top-range bait for searching through the surface layer, wherein

FIG. 3A is a side view, and

FIG. 3B is a front view.

FIG. 4A and FIG. 4B each illustrate a type of terminal tackle with the fishing artificial bait of the present invention in which a hole 24 is provided for receiving and stopping a shank of a hook 16, wherein

FIG. 4A illustrates a suspending-type middle-range crankbait for searching through the middle layer in which a through hole 11 is pierced through an artificial bait body 10 in a downwardly-inclined direction, and

FIG. 4B illustrates a sinking-type bottom-range vibration bait for searching through the deep layer in which the through hole 11 is pierced through the artificial bait body 10 in an upwardly-inclined direction.

FIG. 5A to FIG. 5F illustrate a second artificial bait body 10a having the same structure and the same or different specific gravity from that of the first artificial bait body 10 which can be coupled to a rear portion of the first artificial bait body 10 via a line 14 passed through the through hole 11 and the ring 16a, wherein

FIG. 5A is a side view illustrating a floating-type middle-range crankbait for searching through the middle layer,

FIG. 5B is a top view illustrating the second artificial bait body 10a,

FIG. 5C is a rear view illustrating the second artificial bait body 10a,

FIG. 5D is an exemplary side view illustrating a sinking-type bait to be dragged along a water bottom 23,

FIG. 5E is a top view illustrating the second artificial bait body 10a, and

FIG. 5F is a rear view illustrating the second artificial bait body 10a.

FIG. 6A to FIG. 6E each show a hook to be attached to a line, wherein

FIG. 6A shows a single-point hook,

FIG. 6B shows a two-point hook,

FIG. 6C shows a three-point hook, and

FIG. 6D and FIG. 6E each show a hackled hook.

FIG. 7 illustrates terminal tackles each including an artificial bait body and a hook attached thereto, wherein the upper portion FIG. 7 shows a floating-type bait to be dragged along a water surface 21, the middle portion of FIG. 7 shows a type of bait to be dragged through the middle layer, and the lower portion of FIG. 7 shows a sinking-type bait to be dragged in the vicinity of a water bottom 23.

FIG. 8 shows a terminal tackle with a float attached thereto.

FIG. 9 shows a terminal tackle with a sinker attached thereto.

FIG. 10 is a terminal tackle with a light sinker attached thereto.

FIG. 11A, FIG. 11B and FIG. 11C each illustrate a conventional plug.

### DESCRIPTION OF THE PREFERRED EMBODIMENTS

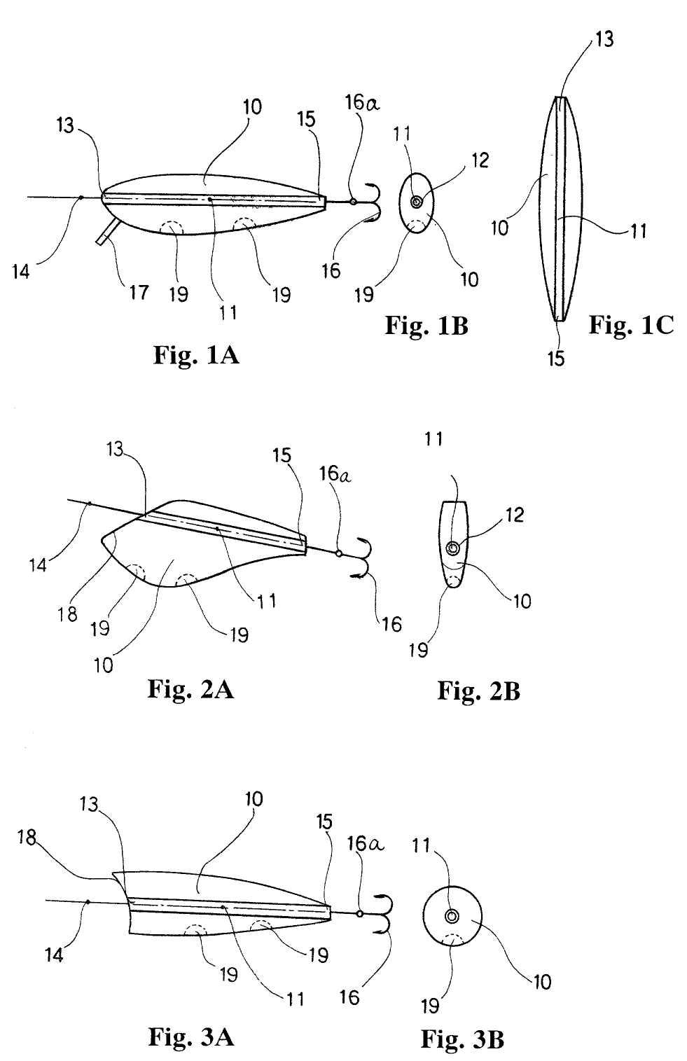

Examples of the present invention will now be described with reference to the accompanying drawings. FIG. 1A to FIG. 1C show a floating-type middle-range crank bait for searching through the middle layer, wherein FIG. 1A is a side view, FIG. 1B is a front view, and FIG. 1C is a top view. The artificial bait body 10 is made of a material whose specific gravity is smaller than that of water, e.g., by cutting a natural material such as wood or through an injection molding of a synthetic resin material such as a plastic. The artificial bait body 10 of a sinking-type bait is made of a material whose specific gravity is greater than that of water.

As is apparent from FIG. 1A to FIG. 1C, the artificial bait body 10 has a spindle shape or a fish shape so as to reduce the resistance in water. As is apparent from FIG. 1B, the artificial bait body 10 has an elliptical cross section as viewed from the front side. A through hole 11 is pierced in a straight shape extending in the longitudinal direction through the central portion of the artificial bait body 10. Although not shown, a through hole may alternatively extend in the transverse direction through the artificial bait body 10, and the through hole may be pierced in a curved shape. A tube 12 is inserted in the through hole 11 as illustrated in FIG. 1B so as to reduce the frictional resistance when passing a line 14 therethrough.

The line 14 is inserted in the through hole 11 from an inlet opening 13 and is pulled out from an outlet opening 15. An end of the line 14 is knotted directly to a ring 16a of a hook 16. Thus, with the ring 16a hitting the outlet opening 15, the hook 16 is prevented from falling off the body 10. In this example, only one hook is attached to the line 14. Since the plug is designed to be dragged through the middle range (middle layer), a lip 17 is provided on the lower side of a front portion of the artificial bait body 10. Moreover, balance weights 19 are embedded in a bottom portion of the artificial bait body 10 in order to keep a balanced posture of the artificial bait body 10.

FIG. 2A and FIG. 2B show a sinking-type bottom-range vibration bait for searching through the deep layer, wherein FIG. 2A is a side view, and FIG. 2B is a front view. The artificial bait body 10 is made of a similar material as described above, with the through hole 11 pierced therethrough, and the tube 12 is inserted in the through hole 11, as described above. The line 14 is inserted from the inlet opening 13 and pulled out from the outlet opening 15 as described above. An end of the line 14 is knotted directly to the ring 16a of the hook 16.

The plug is designed to be dragged through the deep layer, and for this purpose includes a slope portion 18 facing upward which is provided in a front portion of the artificial bait body 10. Thus, when the line 14 is pulled, a downward component of force acts upon the artificial bait body 10, whereby the artificial bait body 10 moves along the bottom of the water according to the pulling force. In order to reduce the resistance in water, the artificial bait body 10 has a slim cross section as illustrated in FIG. 2B. While the through hole 11 is pierced through an upper portion of the body, the balance weights 19 made of a material such as lead are embedded in a bottom portion of the body 10 in order to stabilize the posture of the plug when being pulled and to adjust the buoyancy thereof.

FIG. 3A and FIG. 3B show a popper-type top-range bait for searching through the surface layer, wherein FIG. 3A is a side view, and FIG. 3B is a front view. The artificial bait body 10 is made of a similar material as described above, with the through hole 11 pierced therethrough, and the tube 12 is inserted in the through hole 11, as described above. The line 14 is inserted from the inlet opening 13 and pulled out from the outlet opening 15 as described above. An end of the line 14 is knotted directly to the ring 16a of the hook 16.

The plug is designed to be dragged through the surface layer, and for this purpose includes a slope portion 18 facing downward which is provided in a front portion of the artificial bait body 10. Thus, when the line 14 is pulled, an upward component of force acts upon the artificial bait body 10, whereby the artificial bait body 10 moves in the vicinity of the water surface according to the pulling force. In order to reduce the resistance in water, the artificial bait body 10 has a circular cross section as illustrated in FIG. 3B.

Although not shown in the figures, in each of the examples, the artificial bait body 10 is preferably colored so as to resemble the pattern of small fish, or the like, so as to attract the attention of the game fish.

The silhouette (shape) of the artificial bait body 10 is not limited to those illustrated in the examples above, but may be any other shape which attracts the attention of the game fish. Since nothing is provided on the artificial bait body which is subject to a substantial air resistance, the long-cast capability is improved.

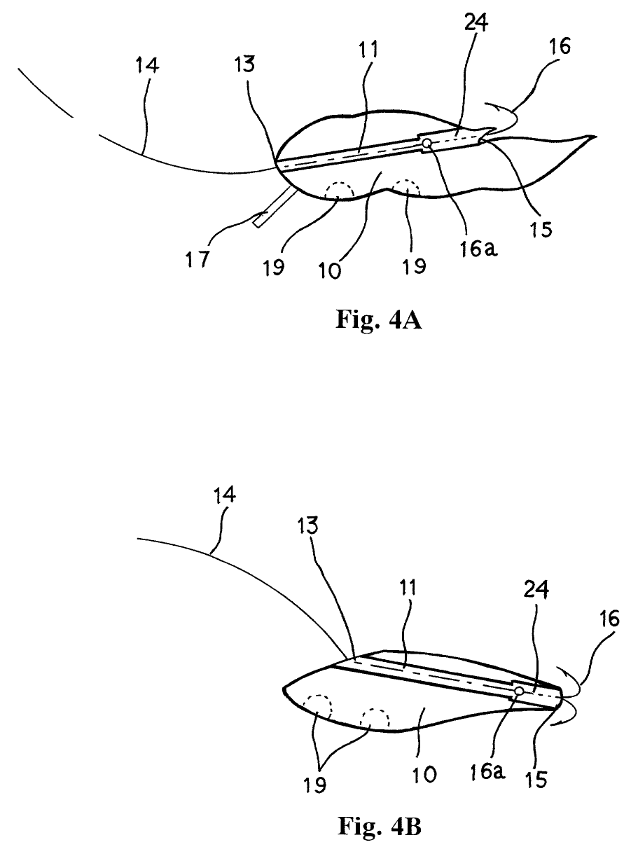

Each of FIG. 4A and FIG. 4B is a side view illustrating a type of terminal tackle with the fishing artificial bait of the present invention in which a hole 24 is provided for receiving and stopping a shank of the hook 16.

FIG. 4A shows a suspending-type middle-range bait for searching through the middle layer in which the through hole 11 is pierced through the artificial bait body 10 in a downwardly-inclined direction. FIG. 4B shows a sinking-type bottom-range vibration bait for searching through the deep layer in which the through hole 11 is pierced through the artificial bait body 10 in an upwardly-inclined direction.

The stop hole 24 for receiving and stopping a shank of the hook 16 is provided in a rear portion of the through hole 11 of the artificial bait body 10 of the present invention. Thus, the through hole 11 and the stop hole 24 are pierced through the fishing artificial bait body 10, and the line 14 is passed through the through hole 11, with the hook 16 being attached to an end of the line 14.

The line 14 is passed through the through hole 11 of the artificial bait body 10 and the hook 16 is attached to an end of the line 14. Then, when the line 14 is pulled, the shank of the hook 16 is received and stopped by the stop hole 24, with only a tip portion of the hook 16 extending out of the artificial bait body 10. This further reduces the visual obtrusiveness.

For a sinking-type bait, when the elliptical stop hole 24 as a hole to receive and stop the hook 16 is provided at the outlet opening 15 of the through hole 11, and the point of a hook of the type shown in FIG. 4A or FIG. 4B (single-point hook or two-point hook) is directed upward, the movement of the hook is suppressed, and there is an effect of reducing the chance of a snag because the hook point is stably directed upward. Due to the structure of this type, the amount of water entering the through hole 11 increases. Therefore, the difference between the specific gravity of the artificial bait body 10 and the specific gravity of water entering the artificial bait body 10 is greater than those of other artificial baits. This provides an advantage that it is easy to produce an artificial bait which is suspended in the water (suspending type) and an artificial bait which sinks slowly (slow sinking type). The artificial bait body 10 can be made of a material having a specific gravity such that the artificial bait body 10 itself would float on a water surface 21 (floating type), with the specific gravity balance of the artificial bait as a whole being such that the artificial bait will be suspended or slowly sink after the line 14 and the hook 16 are attached to the artificial bait body 10 so that the specific gravities of the line 14, the hook 16 and water are added to that of the artificial bait body 10. Then, when the line 14 is cut off in the water due to a snag, or the like, the bait, even if it is a sinking-type bait, will come up to the surface of the water and can be collected.

The present invention also provides a fishing artificial bait including a first artificial bait body having a through hole pierced therethrough, and a second artificial bait body also having a through hole pierced therethrough, wherein the first artificial bait body and the second artificial bait body are coupled together via a line passing through the respective through holes, with a hook attached to an end of the line.

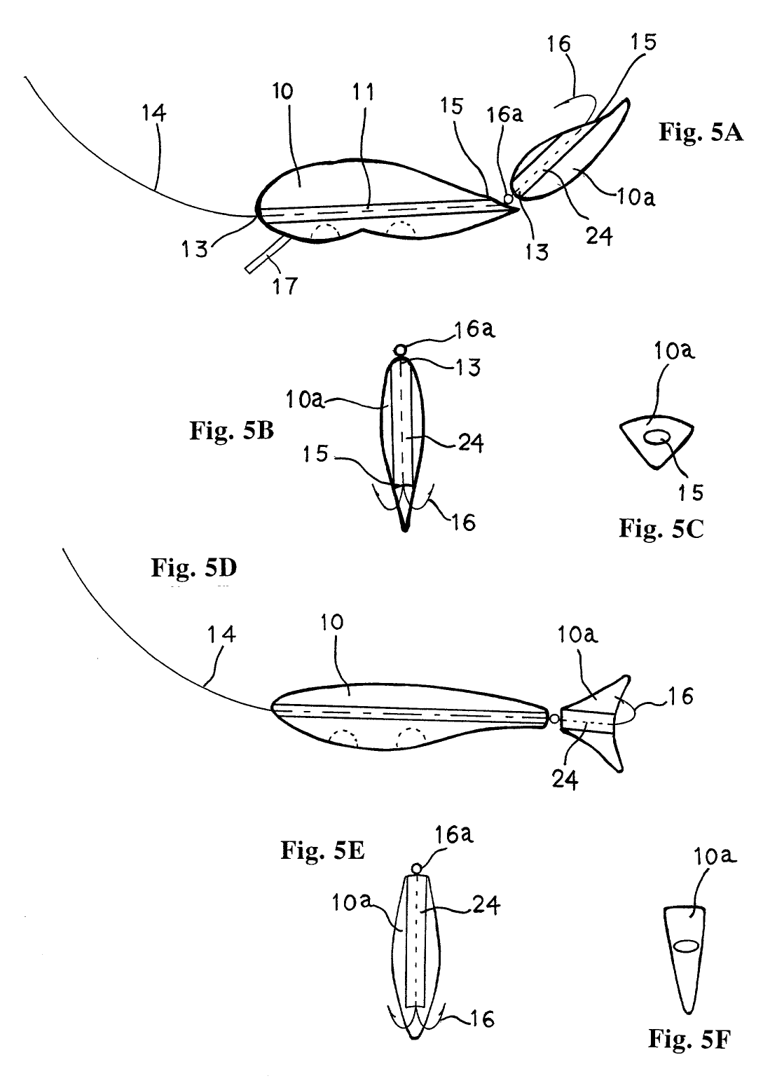

Each of FIG. 5A to FIG. 5F illustrates a second artificial bait body 10a having the same structure but a different specific gravity from that of the artificial bait body 10 which can be coupled to a rear portion of the artificial bait body 10 via the line 14 passed through the through hole 11 and the ring 16a.

FIG. 5A is a side view illustrating a floating-type middle-range crankbait for searching through the middle layer.

FIG. 5B is a top view illustrating the second artificial bait body 10a.

FIG. 5C is a rear view illustrating the second artificial bait body 10a.

FIG. 5D is an exemplary side view illustrating a sinking-type bait to be dragged along a water bottom 23.

FIG. 5E is a top view illustrating the second artificial bait body 10a.

FIG. 5F is a rear view illustrating the second artificial bait body 10a.

As illustrated in the figures, in the example of the present invention, the front-side first artificial bait body 10 resembles the trunk of fish, and the second artificial bait body 10a resembles the tail fin, or the like.

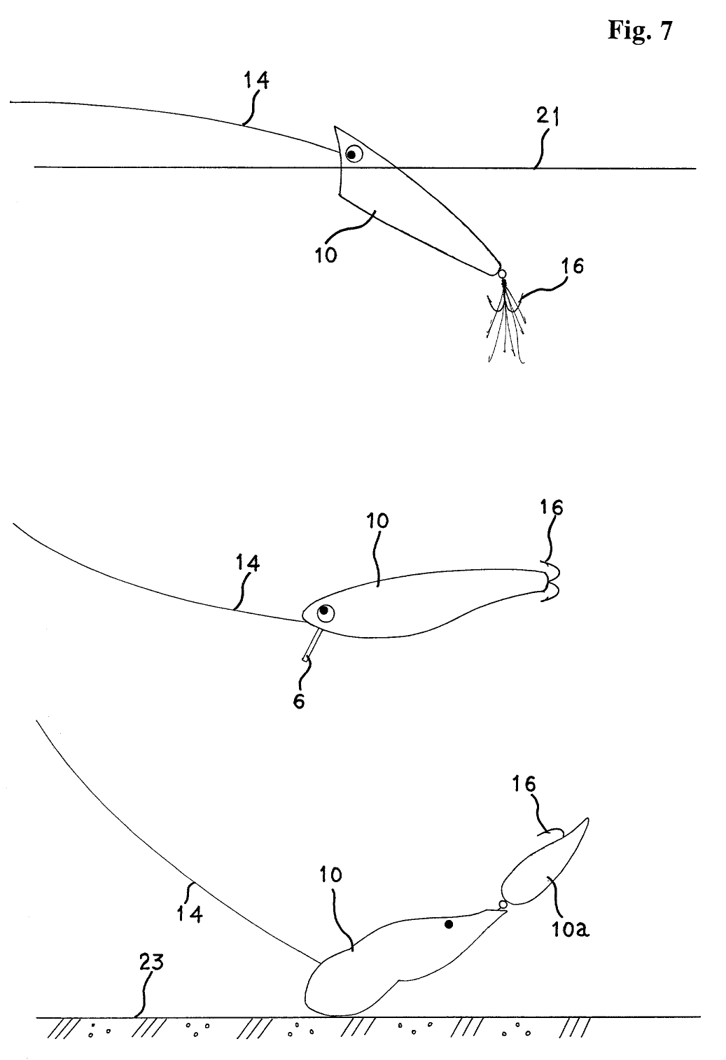

In the case of a sinking type, the rear-side second artificial bait body 10a can be made of a material whose specific gravity is smaller than that of water so that the posture of the artificial bait on the bottom of the water is maintained as illustrated in FIG. 7C, where the rear end portion of the second artificial bait body 10a is directed upward due to buoyancy. Therefore, the hook 16 coupled with the second artificial bait body 10a does not land on the bottom, thereby providing the effect of reducing the chance of a snag and improving the hooking rate.

In the case of a shrimp-type bait as illustrated in FIG. 5A, the rear-side second artificial bait body 10a is claw-shaped. In the case of a fish-type bait as illustrated in FIG. 5D, the rear-side second artificial bait body 10a is tail-fin-shaped. The hook 16 is attached to the second artificial bait body 10a having such a shape. Thus, the visual obtrusiveness is reduced.

In the case of a floating type, the second artificial bait body 10a can be made of a material whose specific gravity is greater than that of the first artificial bait body 10 so that the artificial bait is used with the rear end portion of the second artificial bait body 10a hanging down in the water. However, the main purpose is to ensure that the second artificial bait body 10a to which the hook 16 whose specific gravity is greater than that of water is attached floats toward the water surface so that it does not sink below the front-side artificial bait body 10.

When the upper end portion of the second artificial bait body 10a is thick and the lower end portion thereof is thin, as illustrated in FIG. 5C and FIG. 5F, so as to give a greater buoyancy to the upper end portion, stable floating posture and movement can be obtained.

For the second artificial bait body 10a, the hook 16 can be fixed to the second artificial bait body 10a. Then, even when the line 14 is cut off after casting the artificial bait, the hook 16 does not sink into the water and can be collected together with the second artificial bait body 10a.

Next, the fishing terminal tackle will be described. The hook used in the present invention is a branched hook including a plurality of hook points.

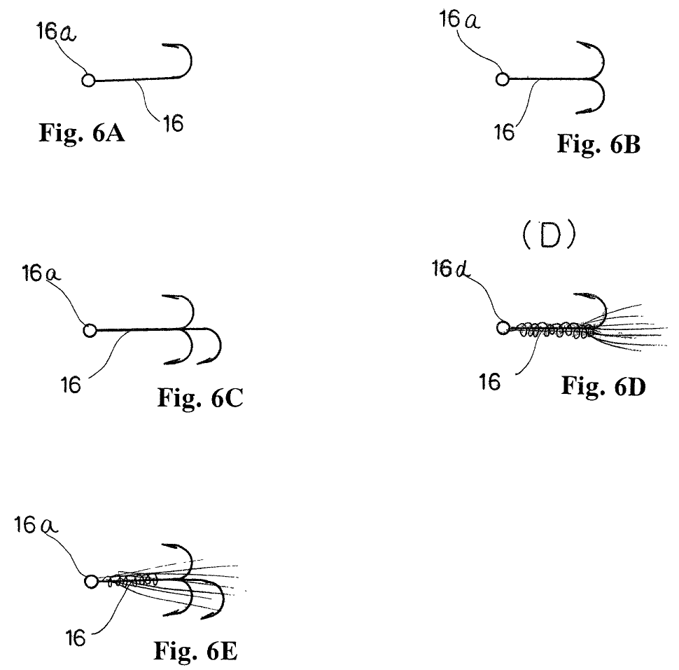

FIG. 6A to FIG. 6E each show the hook 16 to be attached to the line 14, wherein FIG. 6A shows a single-point hook, FIG. 6B shows a two-point hook, FIG. 6C shows a three-point hook, and FIG. 6D and FIG. 6E each show a hackled hook. Each of the hooks includes the ring 16a.

FIG. 7 illustrates terminal tackles each including the artificial bait body 10 and the hook 16 attached thereto. The upper portion FIG. 7 shows a floating-type bait to be dragged along the water surface 21, the middle portion of FIG. 7 shows a type of bait to be dragged through the middle layer, and the lower portion of FIG. 7 shows a sinking-type bait to be dragged in the vicinity of the water bottom 23. In each of the types, after the line 14 is passed through the through hole 11 of the artificial bait body 10 and knotted to the ring 16a of the hook 16, the line 14 is prevented from falling off the artificial bait body 10 by the ring 16a hitting the outlet opening 15 of the through hole 11 pierced through the artificial bait body 10. Note, however, that irrespective of the type of artificial bait, the knot of the line 14, a sprit ring, or the like, may hit the outlet opening 15 of the through hole 11 in order to control the movement of the artificial bait body 10 or the hook 16.

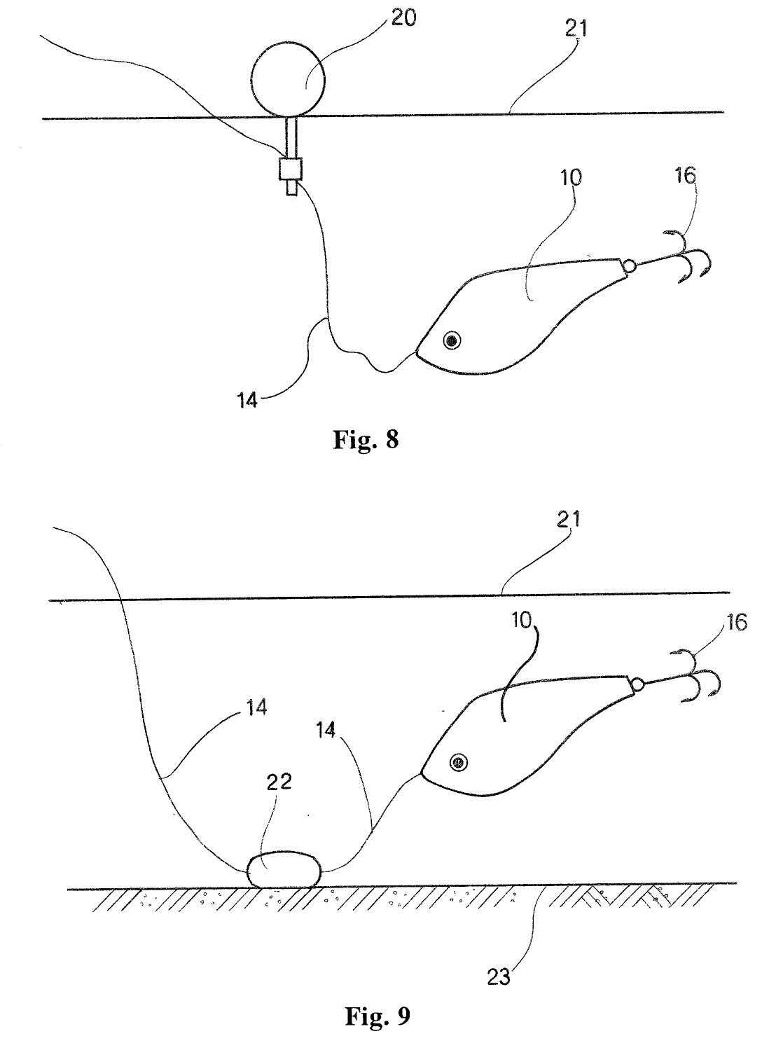

FIG. 8 shows a terminal tackle with a float 20 attached to the line 14. Since the float 20 is floating on the water surface 21, it is possible to visually recognize fish hitting the hook 16 from the movement of the float 20 even if the rod is laid down.

FIG. 9 shows a terminal tackle with a sinker 22 attached to the line 14 instead of the float 20. In such a case, the gravity on the sinker 22 is greater than the buoyancy on the artificial bait body 10, thereby keeping the artificial bait body 10 sunk underwater. When the line 14 is pulled, the sinker 22 moves along the water bottom 23, whereby the artificial bait body 10 moves accordingly in the vicinity of the water bottom 23. This terminal tackle is suitably used for catching fish lurking on the water bottom 23.

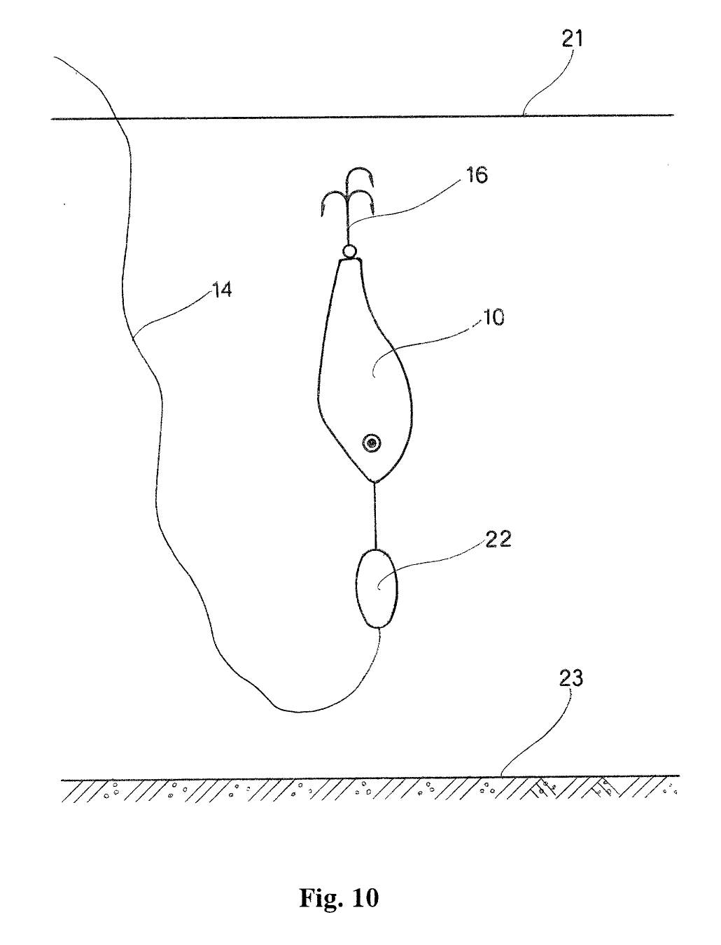

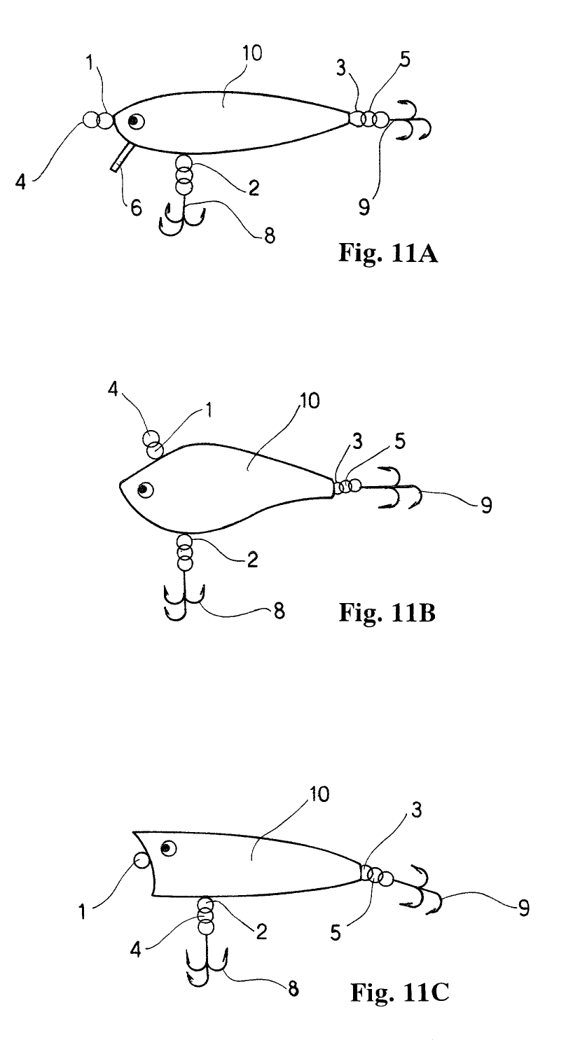

FIG. 10 shows a terminal tackle with a light sinker attached to the line 14. When the buoyancy on the artificial bait body 10 is substantially in equilibrium with the gravity on the sinker 22, the artificial bait body 10 stays in the middle layer under the water surface. The line 14 can be pulled for catching fish swimming in the middle layer.

As has been described above in detail, the artificial bait of the present invention has a minimum structure required for catching fish while minimizing the visual obtrusiveness of the objects on the outside of the artificial bait body, thereby enabling novel use of the line, bait and hook, without being visually obtrusive to the game fish, and thus increasing the catching rate.

Other than the line which is passed through the artificial bait body, no additional parts are attached to the artificial bait body. Thus, the artificial bait body can be inexpensive. When the line is cut off due to a snag, or the like, or when the artificial bait is used while being sunk in the water, the artificial bait body can be easily collected because the artificial bait body comes up on the surface of the water. Moreover, since the gear that is not collected is only the hook, it is possible to minimize the environmental destruction.

In the artificial bait body of the present invention, since the hook is knotted directly to the line, any strike is sensitively and directly transferred to the hand, whereby the user can enjoy the feeling of the battle with the fish. Moreover, even when fish having been hooked struggles violently by jumping or shaking its head, the weight of the artificial bait is unlikely to be transferred to the line and the hook, whereby the chance of a hookout is reduced.

Moreover, the through hole 11 on the outlet opening 15 side is sized so that the shank of the hook can be fitted therein, with only the tip portion of the hook extending out of the artificial bait body, thereby eliminating the visual obtrusiveness. Furthermore, two bodies having different buoyancies can be coupled together via a line passed through the respective through holes so as to control the movement of the bodies.

What is claimed is:

1. A fishing artificial bait, comprising:
an artificial bait body; and
a through hole pierced through the artificial bait body.

2. A fishing artificial bait according to claim 1, wherein the through hole is formed in a straight shape or a curved shape extending in a longitudinal direction or a transverse direction through the artificial bait body.

3. A fishing artificial bait according to claim 2, wherein the fishing artificial bait is a plug.

4. A fishing artificial bait according to claim 3, wherein the artificial bait body is made of a natural material or a synthetic resin.

5. A fishing artificial bait according to claim 4, wherein the artificial bait body has a spindle shape or a fish shape and is colored so as to resemble a pattern of a fish body.

6. A fishing artificial bait according to claim 2, wherein a tube is inserted in the through hole of the artificial bait body.

7. A fishing artificial bait according to claim 3, wherein a lip is attached to the artificial bait body.

8. A fishing artificial bait according to claim 7, wherein a balance weight for keeping a balance of the artificial bait body is embedded in a bottom portion of the artificial bait body.

9. A fishing artificial bait according to claim 6, wherein a hole for receiving and stopping a shank of a hook is provided in a rear portion of the through hole of the artificial bait body.

10. A fishing terminal tackle, comprising:
a fishing artificial bait body; and
a through hole pierced through the artificial bait body,
wherein a line is passed through the through hole, and a hook is attached to an end of the line.

11. A fishing terminal tackle, comprising:
a first artificial bait body having a through hole pierced therethrough; and
a second artificial bait body having a through hole pierced therethrough,
wherein the first artificial bait body and the second artificial bait body are coupled together via a line passing through the respective through holes, with a hook attached to an end of the line.

12. A fishing terminal tackle according to claim 11, wherein a specific gravity of the first artificial bait body and a specific gravity of the second artificial bait body are the same or different from each other.

13. A fishing terminal tackle according to claim 10, wherein a receptacle for receiving and stopping a shank of the hook is provided in a rear portion of the through hole of the artificial bait body.

14. A fishing terminal tackle according to claim 10 or 11, wherein the hook is a branched hook which is branched into one or more hook points.
